(19) United States
(12) Patent Application Publication
(10) Pub. No.: US 2009/0091570 A1
(43) Pub. Date: Apr. 9, 2009

(54) DIVIDING METHOD FOR THREE-DIMENSIONAL LOGICAL PUZZLES

(76) Inventor: Maxime Paquette, Val-Des-Monts (CA)

Correspondence Address: MAXIME PAQUETTE, 575 6E RANG, Val-des-Monts, QC, J8N 7R4, CA

(21) Appl. No.: 12/040,897

(22) Filed: Mar. 2, 2008

Related U.S. Application Data
(63) Continuation-in-part of application No. 11/866,713, filed on Oct. 3, 2007.

(51) Int. Cl. G06T 17/00

(52) U.S. Cl. 345/423

(57) ABSTRACT

A dividing method used to easily divide a solid or hollow structure into perfectly interfitting parts by using at least one guiding polyhedron to establish an axis system serving as guiding paths for associated geometrical figure contours used to slice the structure. This axis system is coincident with all or a subset of the geometrical centers of each face of the guiding polyhedron, with midpoints of the edges of the polyhedron, and with the vertices of the polyhedron. The dividing method is based on five different techniques: a selecting technique, a sizing technique, a multi-slicing technique, a multi-pivoting technique, and a multi-guiding technique. This dividing method can create extremely challenging, aesthetic and symmetrical three-dimensional puzzles having shifting and optionally sliding features. This dividing method works with polyhedral, spherical and odd-shaped structures.

### CROSS-REFERENCE TO RELATED APPLICATIONS

The present application is a continuation-in-part of U.S. patent application Ser. No. 11/866,713 filed Oct. 3, 2007 and bearing the same title.

### TECHNICAL FIELD

The present invention relates generally to a dividing method for easily and efficiently dividing an arbitrarily shaped solid or hollow structure into perfectly interfitting parts, and in particular to techniques for making three-dimensional logical puzzles.

### BACKGROUND OF THE INVENTION

The prior art of shifting-movement puzzles includes regular, semiregular and irregular polyhedra. There are numerous types of polyhedron-based puzzles known in the art. Most of the prior art polyhedron puzzles are based on the five platonic solids and are of very moderate complexity.

Also known in the art are three-dimensional sliding puzzles. Three-dimensional puzzles combining shifting and sliding features have been described by Applicant in U.S. patent application Ser. No. 11/738,673 (Paquette) entitled “Three-Dimensional Logical Puzzles”, which was filed on Apr. 23, 2007.

Also known in the art are ball-shaped or spherical puzzles. Spherical shifting puzzles are very scarce due to the great difficulty of properly dividing a sphere in order to obtain a symmetrical, aesthetic and challenging puzzle.

Spherical puzzles created by dividing a sphere based on a guiding regular polyhedron, i.e. by defining outer spherical sections by dividing the sphere parallel to a guiding polyhedron to create overlapping spherical sections on the sphere, are described by Applicant in U.S. patent application Ser. No. 11/738,673, supra. A spherical puzzle created by this technique is challenging, entertaining and aesthetically pleasing.

Some simple odd-shaped puzzles, such as a human head for example, are known but are generally of a very low difficulty level, again due to the complexity of the shape division involved.

Therefore, complexly subdivided regular, semiregular or irregular polyhedron-based puzzles, or spherical puzzles, or odd-shaped puzzles enabling shifting (and optionally also sliding movement) would provide highly challenging, entertaining and aesthetically-pleasing three-dimensional puzzles.

### SUMMARY OF THE INVENTION

An object of the present invention is to provide an easily applicable, straightforward and efficient dividing method for making challenging, entertaining and aesthetically-pleasing polyhedron-based, spherical-based, or odd-shape-based puzzles having elements that can be shifted and which can optionally further include superimposed sliding elements.

The present specification discloses a novel method of dividing an arbitrarily shaped structure, i.e. an arbitrary three-dimensional solid or hollow structure, into perfectly interfitting parts by using an axis system associated with a guiding polyhedron. The axes are defined as passing through all or a subset of the geometrical centers of every face, the edge midpoints and the vertices of the solid or hollow structure. Each axis serves as a projection path. A planar (two-dimensional) geometrical figure is associated with each axis or projection path. Each geometrical figure has a contour defined by the shape and size of the outer periphery of the particular geometrical figure. As will become apparent from the description below, this contour acts as a “cutting contour” to cut (i.e. slice or divide) the solid or hollow structure into interfitting parts. To cut the solid or hollow structure, the contour is projected along its respective axis (or “projection path”) until it intersects the solid or hollow structure. In other words, this cutting contour can be projected along its axis into the solid or hollow structure to thereby slice the structure to be divided. By projecting each contour along each respective axis, the structure is thereby sliced or divided into perfectly interfitting parts.

Any arbitrary structure (spherical, polyhedral or even odd-shaped) can thus be divided using this method, i.e. by selecting a guiding polyhedron, selecting an axis system based on the guiding polyhedron and by selecting geometrical figures to be associated with each axis of the axis system. The contours of each of these geometrical figures are then projected along their respective axes to intersect the arbitrarily shaped solid or hollow structure.

Each axis of the axis system can be associated with a different geometrical figure. Thus, a plurality of potentially different geometrical figures, each defining its own contour, can be used to cut (i.e. slice or divide) the structure into pieces or puzzle elements. By associating different geometrical figures with each axis, a tremendous variety of puzzles can be generated.

When projecting the contour into intersection with the structure, the contour should remain in a fixed orientation relative to the axis or structure. Preferably, the geometrical figure and its associated contour remain orthogonal to the axis when projected into the structure (but this orthogonality is not necessary to implement this method).

In addition to simply projecting a cutting contour of fixed size and shape along each respective projection path to intersect the structure, the cutting contours themselves can be furthermore made to vary as a function of distance along the projection path, i.e. the shape and size of the cutting contours can change as a function of linear distance along the respective axis. Accordingly, a plurality of variable contours (i.e. contours of variable shape and/or size) can be used to divide the structure. Dividing the structure using a variable contour (that varies as a function of projection distance along the axis) by projecting the variable contour along its respective axis (or projection path) to intersect the structure can thus yield a large number of very interestingly divided puzzles. This technique can be applied to any given solid or to any given hollow structure.

The variable cutting contour can be varied by projecting the contour through a virtual projection tunnel whose central longitudinal axis is coincident and aligned with the projection path or axis. This virtual projection tunnel can have either a fixed cross-section or a variable cross-section and can take a number of different forms, e.g. cylindrical (i.e. fixed), opening/diverging conical (i.e. variable), closing/converging conical (i.e. variable), spherical (i.e. variable), oblong (i.e. variable) and even various odd shapes (i.e. variable or possibly also fixed). In other words, each contour can be projected into an intersecting relationship with the solid or hollow structure by projecting the contour through a variable (or fixed) cross-section projection tunnel of any one of a number of different shapes such as, for example, cylindrical (i.e. constant circular cross-section), conically opening or diverging (i.e. increasing circular cross-section), conically closing or converging (i.e. decreasing circular cross-section), parabolic, sinusoidal, spherical, oblong and even various odd shapes. For example, a circular contour could be projected through a conically converging tunnel to thereby reduce its radius as a function of displacement along the projection path. In this simple example, the tunnel has the effect of varying the size of the contour without varying its shape. Depending on its geometry, the tunnel, can have the effect of varying the shape and/or the size of the contour as it is projected into the solid or hollow structure.

This projection tunnel (like the projection path about which the projection tunnel is centered) is a virtual geometrical construct used to vary the size and/or shape of the geometrical figure contour as a function of the distance along the projection path. Projecting the geometrical figure contour through the projection tunnel causes the two-dimensional size and/or shape parameters of the given geometrical figure contour to vary as a function of projection distance along the projection path running through the center of the projection tunnel.

By properly choosing a suitable guiding polyhedron, axis system, associated geometrical figures and projection tunnels (that govern the geometrical characteristics of cutting contours), an infinity of aesthetic and challenging three-dimensional puzzles can be produced from various solids.

This novel dividing method works with any kind of polyhedral, spherical or odd-shaped structures whether solid or hollow. Any polyhedron can be selected as the guiding polyhedron, but the preferred ones for symmetrical reasons are of the convex uniform kind, such as the platonic solids, the archimedean solids, the waterman solids and the prism and antiprism solids.

This novel dividing method can be easily extended by using superimposed polyhedra for guiding purposes, all of which lies within the scope of the present invention.

### BRIEF DESCRIPTION OF THE DRAWINGS

The embodiments of the present invention will now be described with reference to the appended drawings in which:

FIG. 1A is a schematic depiction of a dividing method in accordance with the present invention;

FIG. 1B is a schematic depiction of a number of exemplary projection tunnels having variable cross-sections for varying the cutting contours as a function of displacement along the projection path in accordance with various embodiments of the present invention;

FIG. 2 illustrates a sphere divided in rotating, mobile and gap elements by circular geometrical figures associated with a guiding tetrahedron;

FIG. 3 is showing a geometrical figure circular radius r_{ng} selected to eliminate the gap elements (tetrahedron face guided);

FIG. 4 is showing a sphere divided by a circular geometrical figure with a circular radius smaller than the no-gap radius r_{ng} (tetrahedron face guided);

FIG. 5 presents the outcome of a dividing radius superior to the no-gap radius r_{ng} (tetrahedron face guided) illustrating the sizing technique of the dividing method;

FIG. 6 shows a double slicing at radius r_{2ng} and rₘₐₓ of the sphere from FIG. 5 representing the multi-slicing technique aspect of the dividing method (tetrahedron face guided);

FIG. 7 also illustrates a double-slicing of a sphere from FIG. 5 with a second radius non-equal to the no-gap radius r_{2ng} (tetrahedron face guided);

FIG. 8 illustrates a combination of a double-sliced circular tetrahedron face division with a circular tetrahedron vertex division presenting the multi-pivoting technique of the dividing method;

FIG. 9 illustrates a circular dodecahedron face division of a sphere;

FIG. 10 is a circular dodecahedron face division of a sphere at the no-gap radius r_{dng};

FIG. 11 illustrates the outcome of a dividing radius superior to the no-gap radius r_{dng} (dodecahedron face guided);

FIG. 12 illustrates a double-sliced circular dodecahedron face division of a sphere;

FIG. 13 is showing a circular icosahedron face division of a sphere;

FIG. 14 shows a combination of a single-sliced circular icosahedron face division with a multi-pivoting single-sliced circular icosahedron vertex division of a sphere;

FIG. 15 is a schematic representation of the dividing method applied to a cube using an octahedron guiding polyhedron;

FIG. 16 illustrates a single-sliced six-pointed star octahedron face to cube vertex division, with a single-sliced octahedral octahedron vertex to cube face division, and a single-sliced hexahedral octahedron edge to cube edge division of a cube for non-puzzle purposes;

FIG. 17 illustrates a single-sliced circular octahedron face to cube vertex division of a cube suited for puzzle purposes;

FIG. 18 is a combination of a single-sliced circular octahedron face to cube vertex division with a mutli-pivoting single-sliced circular octahedron vertex to cube face division applied to a cube;

FIG. 19 illustrates an exploded view of an odd-shape puzzle divided by a single-sliced tetrahedron face division;

FIG. 20 is an assembled view of FIG. 19 showing the extended possibilities of the dividing method applicable to any odd-shaped solid; and

FIG. 21 illustrates a plurality of different holding means or retaining means that can be used to interconnect puzzle elements.

These drawings are not necessarily to scale, and therefore component proportions should not be inferred therefrom.

### DESCRIPTION OF THE PREFERRED EMBODIMENTS

By way of introduction, the novel dividing method will be illustrated with simple preferred embodiments related to a regular guiding polyhedron. It is to be understood that any polyhedron or combination of polyhedra can be used as the guiding polyhedron associated with the axis system, all within the scope of the present invention.

The dividing method presented in this disclosure involves a combination of techniques: a selecting technique, a sizing technique, a multi-slicing technique, a multi-pivoting technique, and a mutli-guiding technique which can be used in various combinations to create symmetrical, aesthetic and challenging puzzles, or simply to divide any given solid or hollow structure into perfectly interfitting parts. Of the five techniques presented herein only the two first (selecting technique and sizing technique) are essential to the dividing method. The three remaining techniques are optionally used to increase the puzzle's complexity.

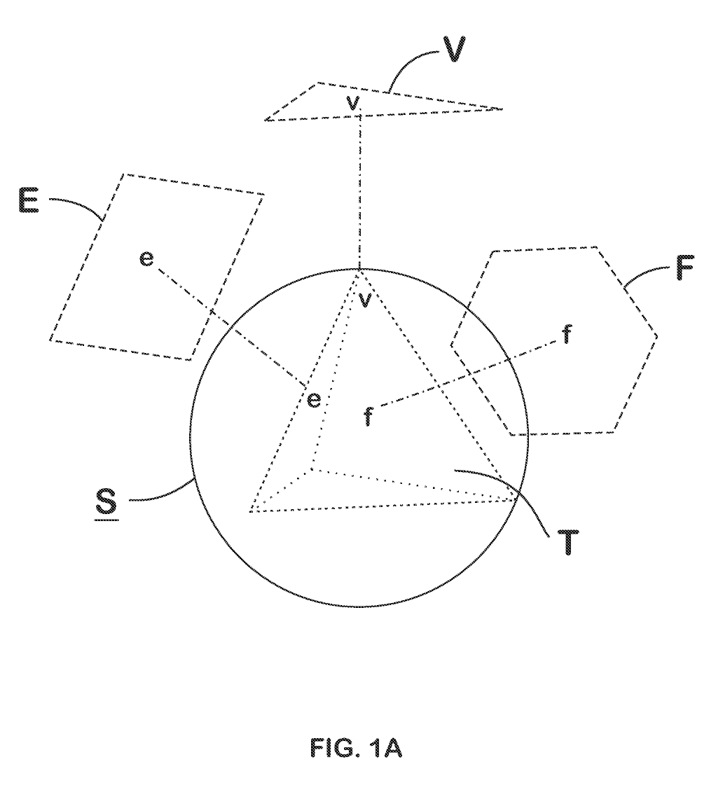

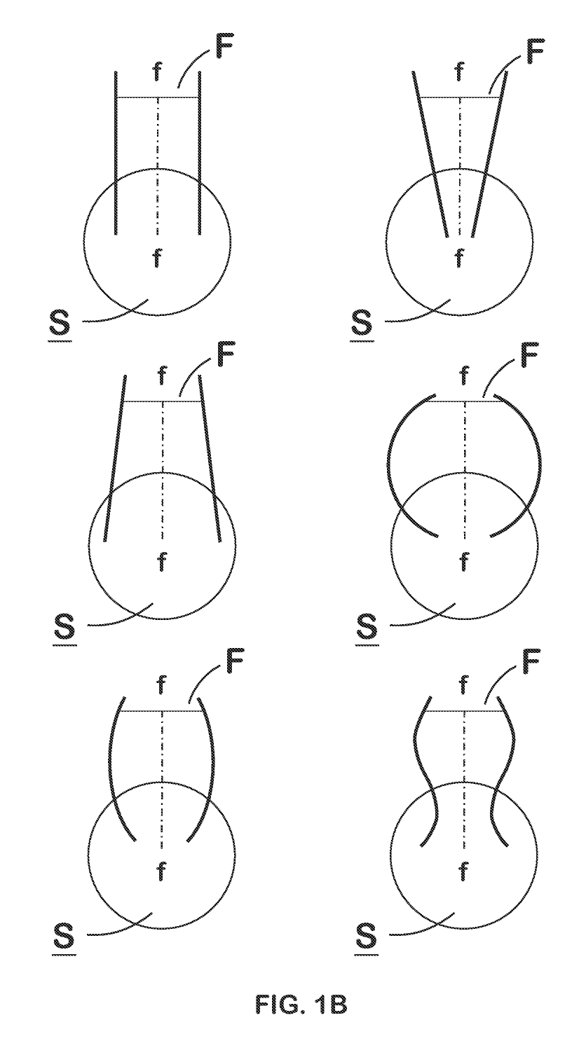

Reference is now made to FIG. 1A. In this schematic representation of the dividing method, the given solid to be divided is represented by a sphere S with an inscribed tetrahedron T. The guiding tetrahedron could have been shown inscribed or subscribed without any differences since it is the axis system associated with the polyhedron that is relevant to the dividing method. For each face of the guiding polyhedron there is an associated axis f-f also associated with a geometrical figure F. Each axis f-f, four in the case of a tetrahedron, can be associated with a different geometrical figure F. Alternatively, all or a subset of the axes f-f can share a common figure F. The axis system is completed by having vertex axis v-v and midpoint edge axis e-e associated respectively with geometrical figures V and E.

Reference is now made to FIG. 1B. For each associated axis f-f, e-e or v-v, a projection tunnel is selected (or defined). The projection tunnel, which is a virtual tunnel, i.e. a purely geometrical construct, may be a variable cross-section projection tunnel (e.g. a cone or a parabola) or a constant cross-section tunnel (e.g. cylinder). The projection tunnel has a projection path aligned and coincident with a respective axis f-f, e-e or v-v. The geometrical figure defines a cutting contour that is to be used to slice the solid or hollow structure. The geometrical figure contour is thus defined by the shape and size of the virtual projection tunnel. The cutting contour (i.e. the geometrical figure contour) is confined by the tunnel while remaining in a fixed orientation (preferably but not necessarily orthogonal) to the respective axis or projection path). This contour is made to vary in shape and/or size as it is projected through the tunnel to thus intersect the solid or hollow structure to be divided. Therefore, as the cutting contour is projected, the size and/or shape of the cutting contour may be made to vary if the projection tunnel has a variable cross-section. Alternatively, if the projection tunnel has a fixed cross-section, then the size and shape of the cutting contour will remain constant as it sections through the solid or hollow structure to be divided.

Where the projection tunnel causes the geometrical figure contour (cutting contour) to vary as it sections through the structure to be cut, this tunnel can be referred to as a variable cross-section projection tunnel. Otherwise, if the geometrical figure contour remains fixed in terms of size and shape, then it is a constant cross-section projection tunnel. A different projection tunnel can be used for each axis, or alternatively all or a subset of the axes can share a common projection tunnel. The projection tunnels along the associated axes followed by the geometrical figure contours can be of many different forms. Some forms of possible projection tunnels are illustrated as cross-sectional views for the geometrical figure F and its associated axis f-f. These projection tunnels can be cylindrical, converging conical or diverging conical, parabolic, pyramidal, sinusoidal, spherical, oblong and even odd shaped.

The preceding selection of the guiding polyhedron, axis system, associated geometrical figures and projection tunnels is said to be the selecting technique of the dividing method. This selecting technique provides the contour or contours that are to be projected along their respective axes to section (divide, slice or cut) the given solid or hollow structure into perfectly interfitting parts.

As mentioned, the first technique involved in the dividing method is the selecting technique. This technique refers mainly to the selection of the proper form of every geometrical figure contour associated with an appropriate axis system and variable cross-section projection tunnels to be used for slicing the given solid or hollow structure.

The second technique involved in the dividing method is the sizing technique. This technique refers to the selection of the proper dimension, or size, of every associated geometrical figure. Proper selection of the geometrical figures and proper sizing of these figures are essential to the dividing method and depend on the expected purposes of the divided solid or hollow structure. As a general rule for puzzle purposes, very symmetrical parts are sought and as many as possible parts should be interchangeable (shifting-wise). So mostly circular figures are used for puzzle purposes with quite a bit of overlapping of the geometrical figures.

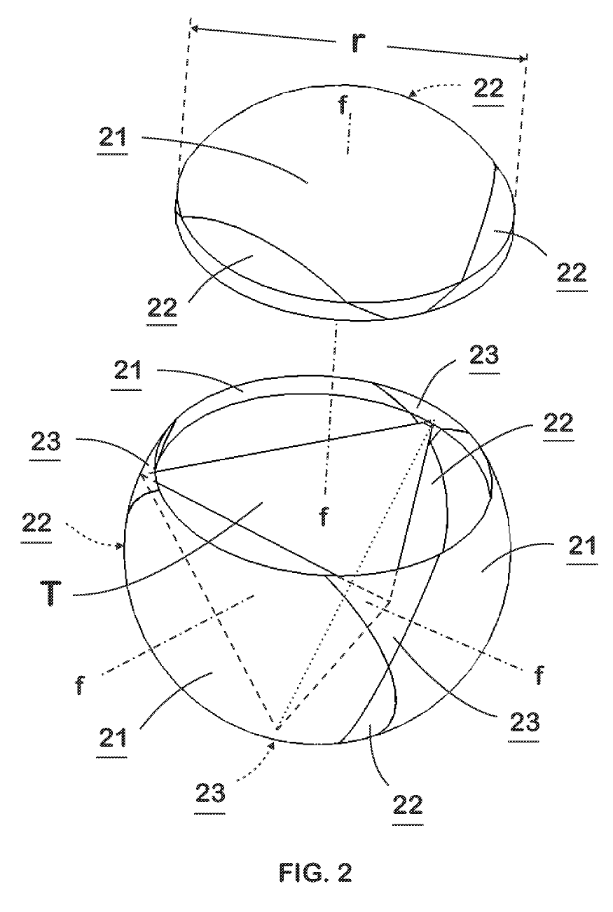

Reference is now made to FIG. 2 illustrating a sphere divided by a circular geometrical figure of radius r associated with the face axis f-f of a guiding tetrahedron T. The sphere is divided using cylindrical intersecting surface shapes into four rotating elements 21, six mobile elements 22 and four gap elements 23.

The mobile elements 22 are grouped around each of the rotating elements 21 in shifting sections whereby mobile elements of one group can be interchanged with mobile elements of other groups. Thus, a shifting spherical puzzle is created by dissecting a sphere with circular geometrical figures (that act as cutting surfaces) that are associated with each face axis f-f of a guiding tetrahedron T to generate overlapping outer spherical sections, each centered about a respective rotating element 21.

Some adjustments are needed to convert the elements of the given solid or hollow structure into a functioning puzzle. These are well described in the prior art and need no further explanation other than mentioning that:

(i) each rotating element is connected to the puzzle by a retaining means, i.e. a fastener, fastener subassembly, retainer or other retaining mechanisms. These retaining means hold the pieces in an interfitting relationship and enable rotational movement around the associated axis. These retaining means could include a coil spring to reduce friction generated between adjoining surfaces and provide easily movable elements that are not prone to jamming, catching or getting “hung up”. These interconnecting means could be replaced by snapping-action parts, which would also fall within the scope of the present invention;

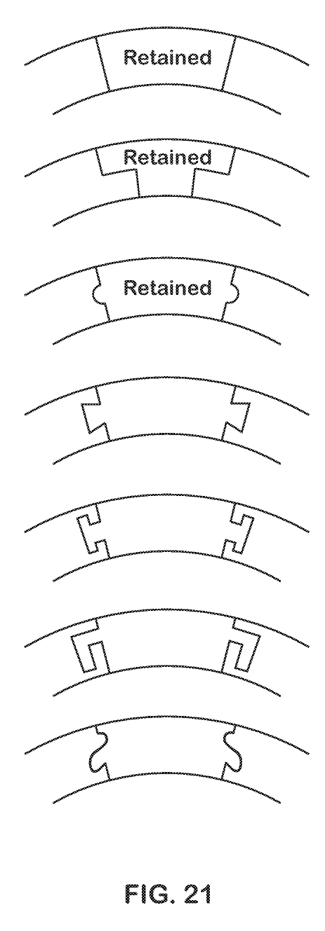

(ii) holding means are provided for holding the remaining elements in an interfitting relationship with each respective rotating element, or adjacent remaining elements. Usually, the angles formed in the divided parts are such that remaining elements cannot slide out of their fitted position, thus preventing disassembly of the puzzle. Other interfittings, mechanisms or locking means are possible that enable elements to be interchanged from one group or subgroup to another group or subgroup by “shifting” (i.e. twisting or rotating) one group or subgroup relative to the other groups or subgroups. For example, locking means could include a tongue and groove mechanism. It is understood that this groove could be male (protrusion) or female (cavity), and of many shapes like dovetail-shaped, L-shaped or T-shaped or of any shape that provides a holding means allowing rotation about an axis, all within the scope of the present invention. Some exemplary holding means are presented in FIG. 21.

(iii) the obtained puzzle can be designed with or without a center element or core located inside of the given solid puzzle, which can be either (a) an inner sphere, or (b) an internal concentric polyhedron, or (c) an axial rod (pivot) system. Depending on the guiding polyhedron used and the selected dividing geometrical figures, the center element may or may not have exposed faces. A coreless puzzle can be constructed by providing the rotating elements, mobile elements, gap elements, and the remaining elements, if applicable, with appropriate protrusions and grooves. These protrusions and grooves cooperate as interfitting male and female connections to slideably and rotatably interlock the various elements to thus hold the elements together to form a complete solid puzzle. Also, the center element could be constructed by the interfitting or snapping action of two half center core elements. When assembled together these two half center core elements form a hollow center core element shaped as a polyhedron or a sphere. With this hollow center core element, the rotating elements are rotationally connected to the core element by a screw inserted from inside the puzzle and thus no capping of elements is required in order to obtain an even and smooth outer surface over the given solid outer shell of the puzzle. All of the previously mentioned possibilities or modifications lie within the scope of the present invention.

The foregoing adjustments (or other similar adjustments well within the capabilities of a person of ordinary skill in the art) are needed to convert the given solid elements in the puzzles presented in the remaining figures of this disclosure so as to obtain functioning (shiftable) puzzles. These modifications and adjustments are well within the reach of a person familiar with the art of three-dimensional puzzles and therefore require no further elaboration.

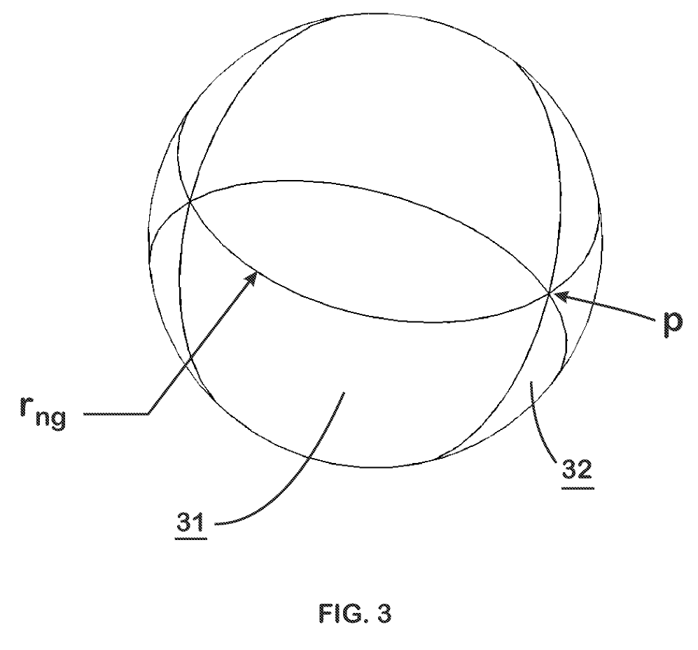

FIG. 3 to FIG. 5 illustrate the huge influence that the sizing technique has on the resulting puzzle parts. That influence is translated into different types, forms and numbers of elements.

Reference is now made to FIG. 3 which shows a spherical solid divided by circular geometrical figures of radius r_{ng} associated with the face axis of a guiding tetrahedron. It is the exact same selecting technique of the dividing method used in FIG. 2 except that the sizing of the circular geometrical figures is selected to eliminate the gap elements 23 of FIG. 2. This is achieved when the slicing contours meet at point P. Thus, the obtained puzzle only has two types of elements, rotating elements 31 and mobile elements 32.

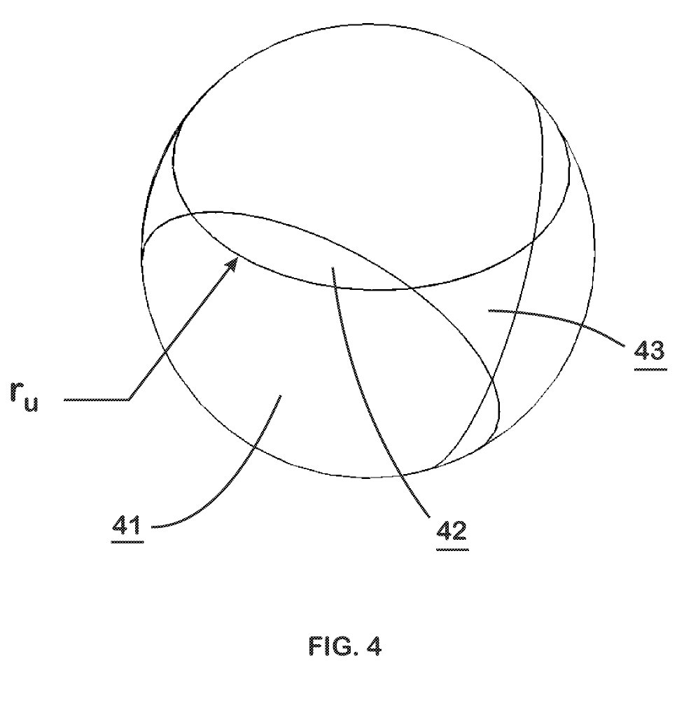

Reference is now made to FIG. 4 showing the result of the exact same selecting technique of the dividing method used in FIG. 2 and FIG. 3 with a circular radius rᵤ of the geometrical figures sized smaller than the no-gap radius r_{ng}. This division of the given solid is said to be “tetrahedron face guided” exactly as with the previous puzzle. This puzzle is constitued of three types of elements, pivoting elements 41, mobile elements 42, and gap elements 43.

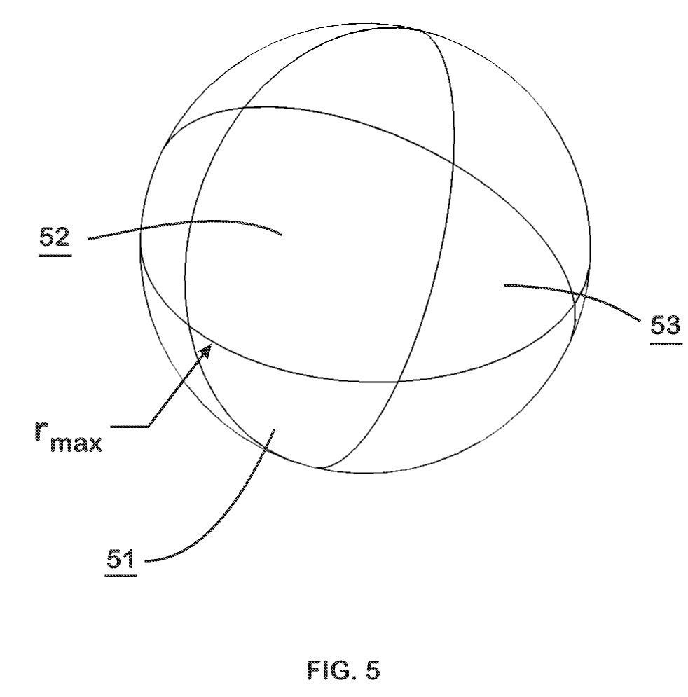

Reference is now made to FIG. 5 illustrating a tetrahedron face guided division of a sphere with a sizing of the circular geometrical figure radius rₘₐₓ superior to the no-gap radius r_{ng}. This puzzle is also constitued of three types of elements, pivoting elements 51, mobile elements 52, and gap elements 53 of different size and shape compared to the puzzle depicted in FIG. 4.

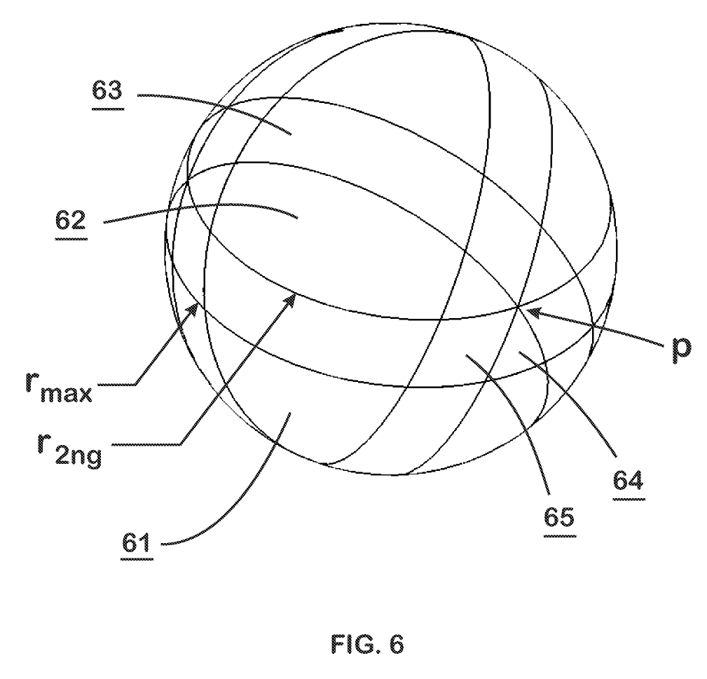

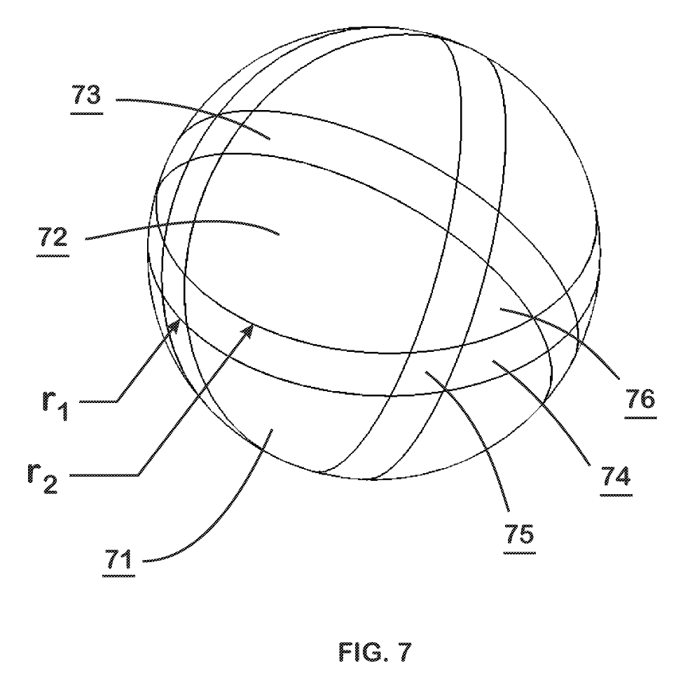

FIG. 6 and FIG. 7 illustrate the multi-slicing technique used to increase the number of parts that are interchangeable on a given puzzle. This multi-slicing technique is simple, straightforward and very efficent in creating challenging symmetrical puzzles.

Reference is now made to FIG. 6 where the multi-slicing technique is presented in the form of a double slicing at radius rₘₐₓ and r_{2ng} (contours meeting at point P) of the sphere from FIG. 5. The spherical puzzle is now constituted of five different types of elements, rotating elements 61, mobile elements 62, secondary mobile elements 63, secondary gap elements 64, and inter-gap elements 65. Since the multi-slicing technique of a given puzzle using the same proposed selecting and sizing techniques will easily result in a different quantity of elements and different types of elements, it allows one to vary the total number of puzzle puzzle elements to achieve either simpler or more complex puzzles. It is to be understood that these simpler or more complex puzzles are within the scope of the invention presented in this disclosure. Also to be understood is that various combinations, changes or modifications are possible giving almost an infinity of possibilities if the dividing method is used with other regular, semiregular, irregular, spherical or odd-shaped given solid.

Reference is now made to FIG. 7 illustrating a tetrahedron face guided double-slicing of the sphere from FIG. 5 with a first radius r₁ and a second radius r₂ different from the no-gap radius r_{2ng}. The outcome of this division is now six different types of elements, rotating elements 71, mobile elements 72, secondary mobile elements 73, secondary gap elements 74, inter-gap elements 75, and gap elements 76.

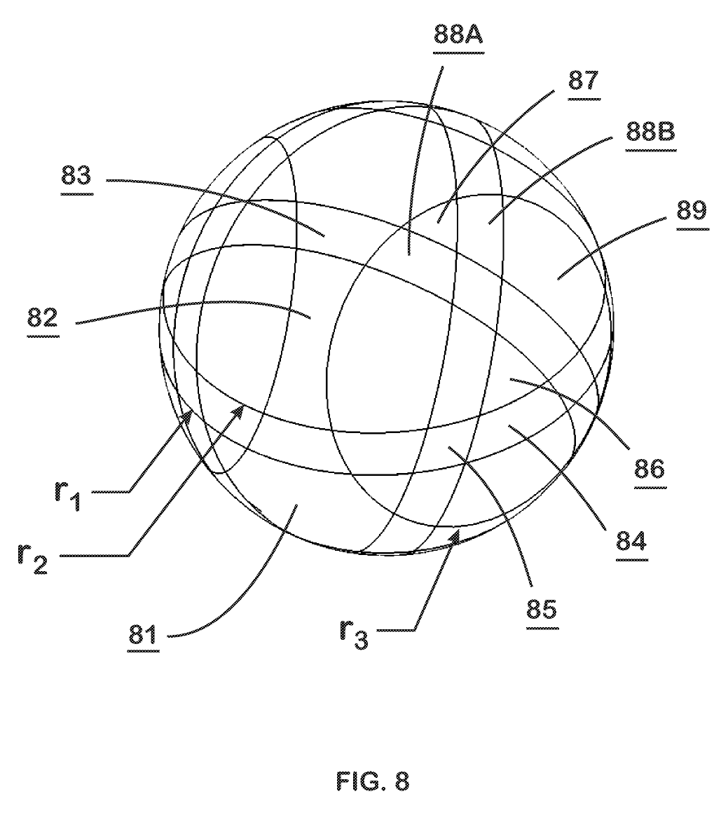

FIG. 8 presents another technique being part of the dividing method, the multi-pivoting technique. This technique is used to incorporate pivoting features around previously non-pivoting elements. The multi-pivoting technique is also very simple, straightforward and also very efficent for increasing the number of parts interchangeable on a given solid puzzle, thus creating ultimately challenging symmetrical puzzles.

Reference is now made to FIG. 8 illustrating the puzzle of FIG. 7 submitted to the multi-pivoting technique by introducing a said “tetrahedron vertex division” through circular geometrical figures of radius r₃. This tetrahedron vertex division is carried along axes coincident with the guiding polyhedron vertices. It can be appreciated that the complexity of the puzzle rapidly increases. The puzzle being now constituted of ten elements, rotating elements 81, mobile elements 82, secondary mobile elements 83, secondary gap elements 84, inter-gap elements 85, gap elements 86, secondary pivoting elements 87, first inter-mobile elements 88A, second inter-mobile elements 88B, and tertiary mobile elements 89.

The last technique of the dividing method, the “multi-guiding technique”, relates to the use of multiple guiding polyhedra used to divide one given solid. This technique corresponds to the superposition of different divisions from different polyhedra into only one puzzle. The results of such superposition become rapidly complex and for the sake of simplicity only puzzles based on single guiding polyhedron are presented in this disclosure. However, it will be obvious to a person familiar with the art of three-dimensional puzzles, that this technique alone is an extremely powerful tool to create astonishingly complex and intriguing puzzles aimed at the expert enthusiast. But as mentioned in the prior art, with proper indicia pattern selection, the puzzle difficulty level can be modulated to obtain a reasonably solvable puzzle.

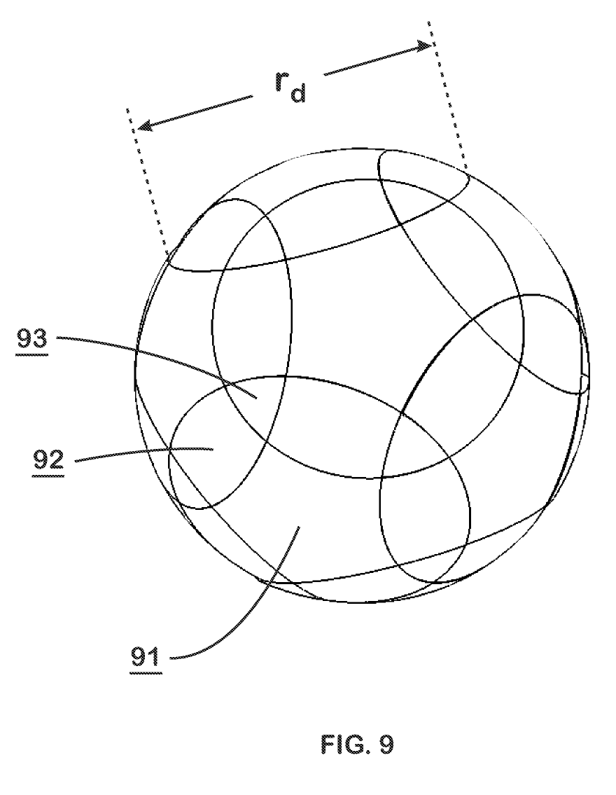

FIG. 9 to FIG. 18 will now be devoted to illustrate the power of changing the guiding polyhedron used to divide a simple solid. This will enable a puzzle developper to appreciate the powerful dividing method disclosed herein. It is to be mentioned that only some of the five platonic solids are used as the guiding polyhedron in the present disclosure, but that any polyhedron showing some kind of symmetry can be used for puzzle purposes. This requirement is not necessary if only a division of a given solid into perfectly interfitting parts is sought. Accordingly, the best suited polyhedra to be used in the dividing method for puzzle purposes are of the convex uniform kind, such as the five platonic solids, the thirteen archimedean solids, the waterman solids and mostly all of the prism and antiprism solids.

Reference is now made to FIG. 9 illustrating a circular dodecahedron face division of a sphere. The associated geometrical figures are circular with a contour radius r_{d}. The result of this division is twelve pivoting elements 91, thirty mobile elements 92, and twenty gap elements 93. This exact puzzle is presented by the Applicant in the prior art with a different dividing method. The dividing method of the present disclosure is more general.

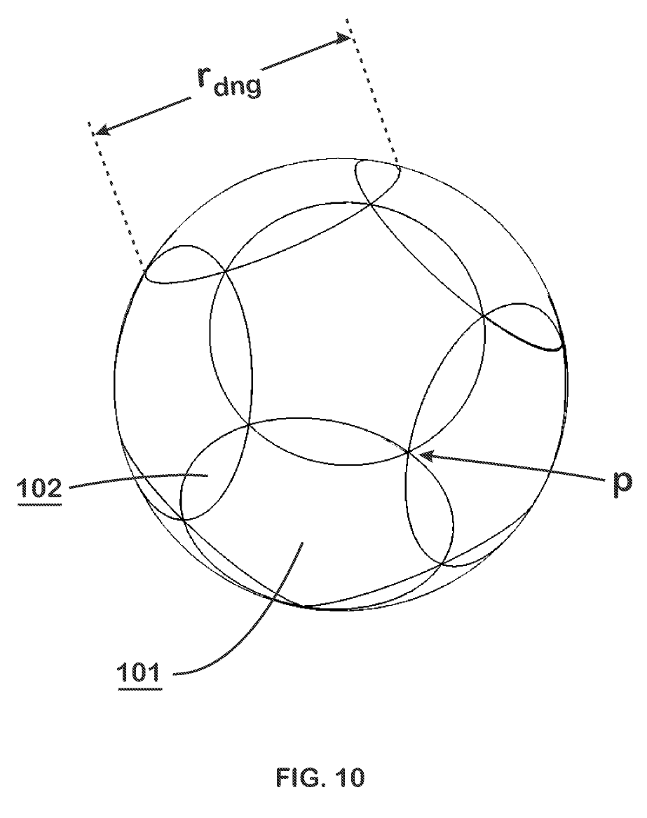

Reference is now made to FIG. 10 showing a circular dodecahedron face division of a sphere at the no-gap radius r_{dng}. With such a radius the contours projected on the sphere surface meet at point P, and thus no gap elements are produced leaving only pivoting elements 101 and mobile elements 102 covering the entire outer surface of the divided sphere. One can contemplate that the effect of the sizing technique is very similar either with a tetrahedron guided division or a dodecahedron guided division.

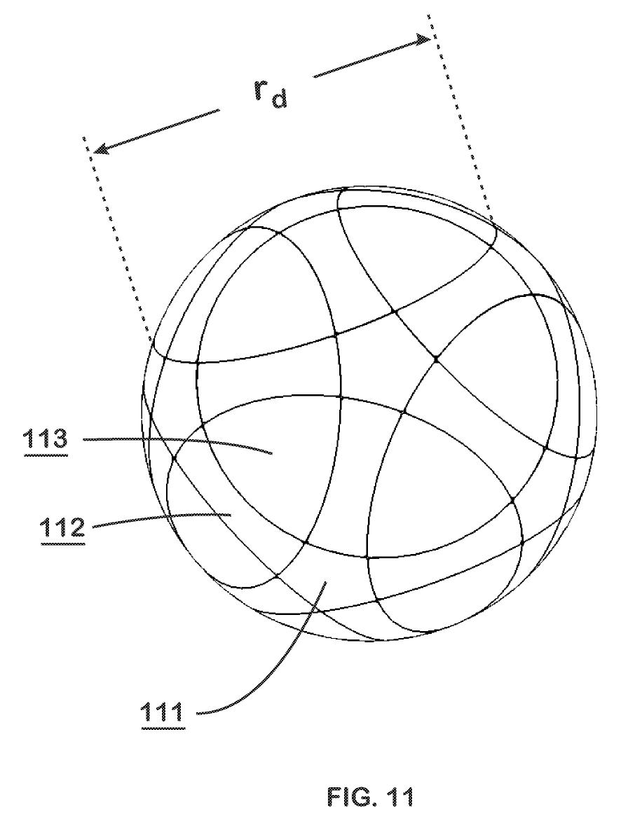

Reference is now made to FIG. 11 showing quite a large difference between elements of the present figure compared to elements of FIG. 9. This large difference is obtained simply by enlarging the associated geometrical figure contour radius r_{d}. There are also three types of elements obtained by this division, pivoting elements 111, mobile elements 112, and gap elements 113. Puzzlewise, such a configuration is superior since a larger portion of the sphere's surface moves while playing the puzzle. So the fixed portion and the moving portion of a puzzle surface can be adjusted by the puzzle designer at will. This constitutes a big advantage when adapting the puzzle to different purposes, such as creating promotional vehicles, designing simple puzzle for kids or designing complex puzzles for the expert puzzle enthusiast.

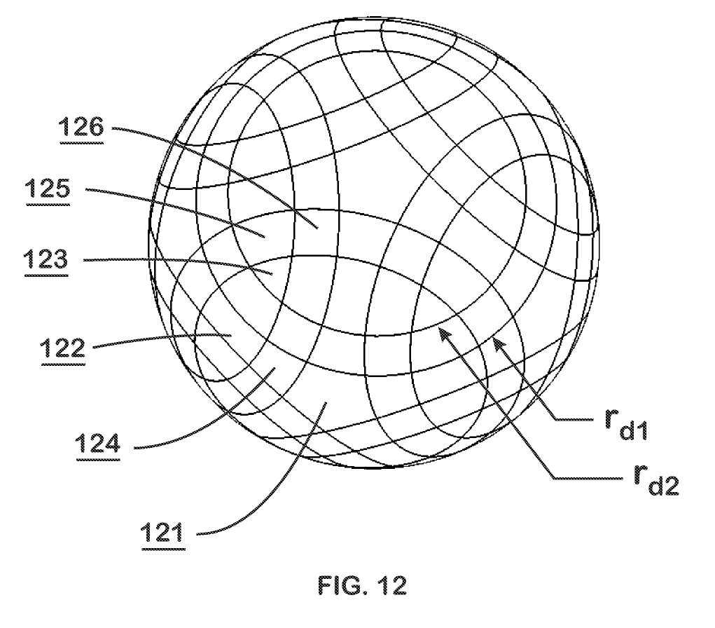

Reference is now made to FIG. 12 in which a double-sliced circular dodecahedron face division applied to a sphere such as the one in FIG. 11 is shown. This double-slicing is carried with the same geometrical figure along the same guiding axis, except with two different radii r_{d1} and r_{d2}. It can be appreciated that a very interesting, symmetrical puzzle is obtained. This puzzle being constitued of six different types of elements, pivoting elements 121, mobile elements 122, gap elements 123, secondary mobile elements 124, secondary gap elements 125, and inter-gap elements 126. Here also the dedocahedron multi-slicing division is very similar to the tetrahedron multi-slicing division.

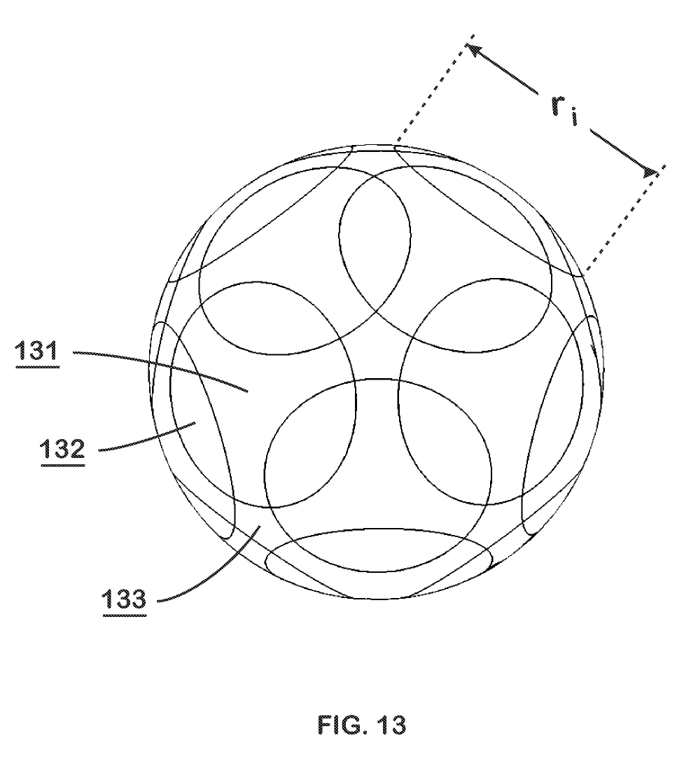

Reference is now made to FIG. 13 showing a circular icosahedron face division of a sphere at radius rᵢ. Since the guiding polyhedron is an icosahedron there will be twenty pivoting elements 131, with the remaining of the puzzle's outer surface covered by mobile elements 132 and gap elements 133. Due to the great number of pivoting elements involved one can anticipate that the icosahedron family puzzles would be very challenging.

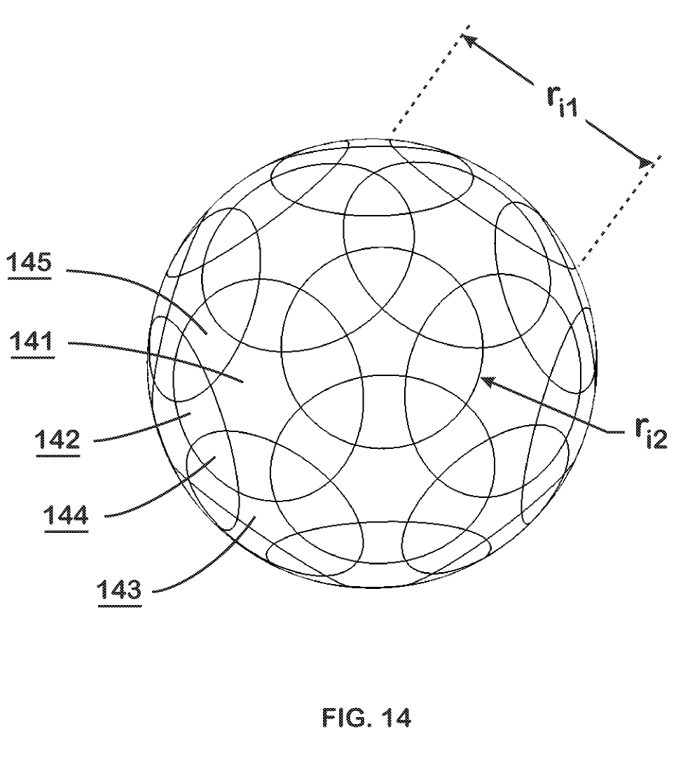

Reference is now made to FIG. 14 illustrating an application of the multi-pivoting technique applied to the icosahedron-based puzzle of FIG. 13, sliced at radius rᵢ₂. The number of different elements is now five, namely pivoting elements 141, mobile elements 142, gap elements 143, secondary mobile elements 144, and secondary pivoting elements 145. Great similarities exist with the previous puzzles. It is possible to anticipate a large magnitude of permutations resulting from the application of a multi-slicing technique to such an icosahedron-based puzzle. Also, by introducing a multi-guiding technique to this family of puzzles, a countless number of puzzles could be obtained, and these would be almost impossible to solve unless appropriate visual indicia patterns were used to modulate (simplify) the difficulty level of these puzzles.

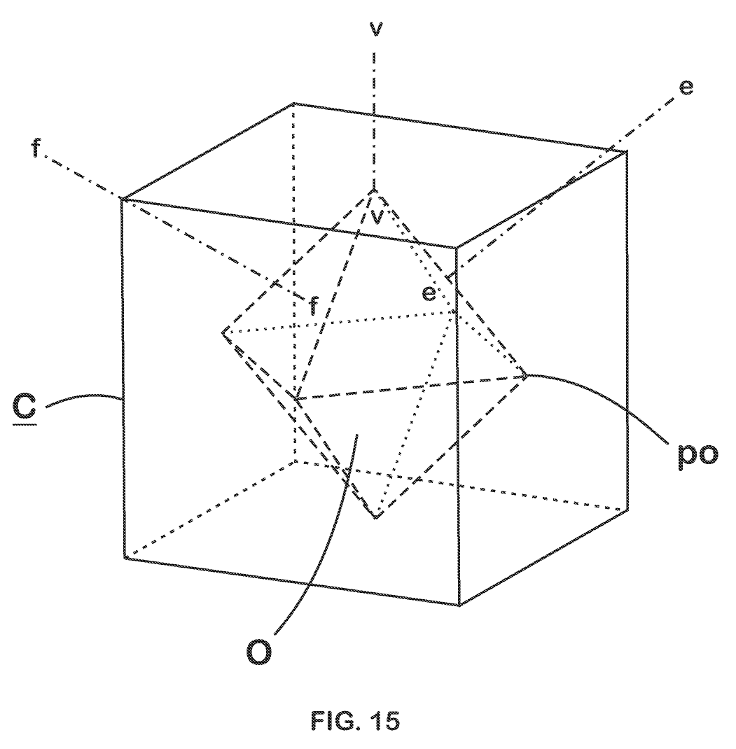

Reference is now made to FIG. 15 showing the proposed dividing method applied to a cubic solid. In this schematic representation of the dividing method, the given solid to be divided is represented by a cube C with an inscribed octahedron O. For each face of the guiding polyhedron there is an associated axis f-f passing through a cube vertex, since the guiding octahedron is positioned such that its vertices are coincident with the geometrical centers of each cube face (point po). Not shown are associated geometrical figures F. The axis system is completed by having vertex axis v-v passing through the geometrical centers of each cube face, and midpoint edge axis e-e passing through cube edge midpoints. Also not shown are the associated geometrical figures V and E. The contours of the associated geometrical figures F, V, E are then used through projection along their respective axes to divide, or slice, the cubic solid into perfectly interfitting parts.

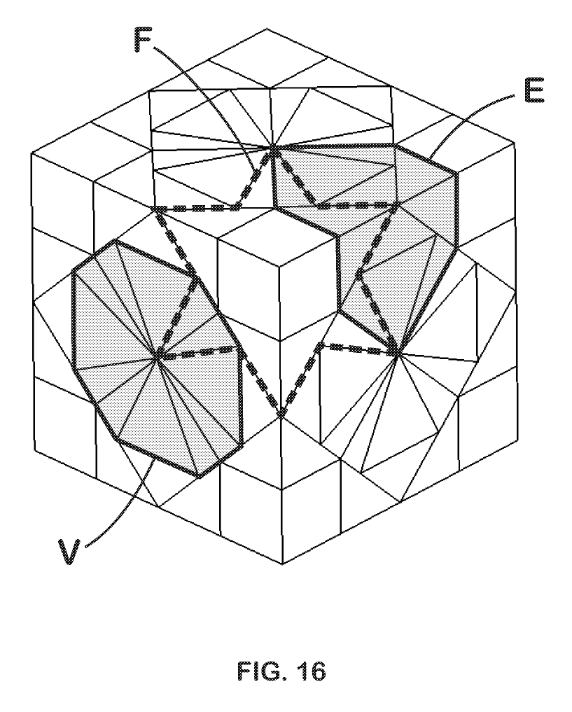

Reference is now made to FIG. 16 in which the associated geometrical figures F are six-pointed stars, the figures V are octagonals, and figures E are hexagonals used for dividing the cube-shaped solid. The preceding division is described as a single-sliced six-pointed star octahedron face to cube vertex division, with a single-sliced octagonal octahedron vertex to cube face division, with a single-sliced hexagonal octahedron edge to cube edge division of a cube. The resulting divided cube is not realistically intended to be implemented as a puzzle, but this however illustrates the extreme possibilities of the dividing method.

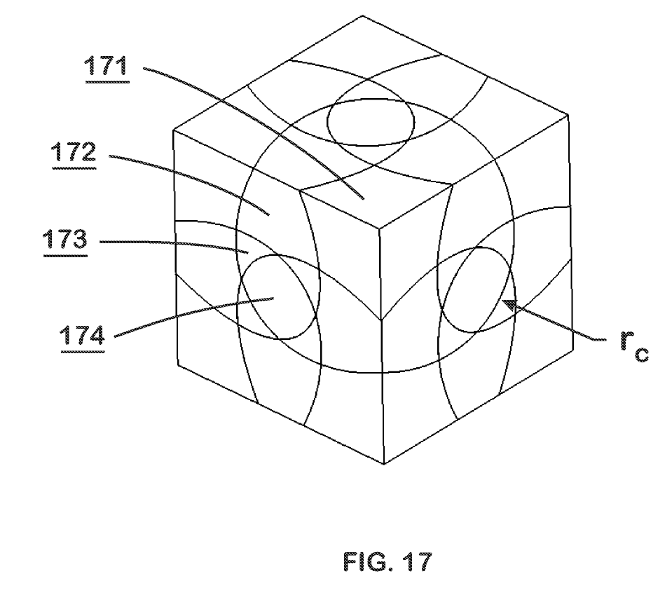

Reference is now made to FIG. 17 illustrating a single-sliced circular octahedron face to cube vertex division of a cube suited for puzzle purposes. This division being carried at radius r_{c}. The resulting cube is of a completely novel aspect. The complete cube can be assembled from only four different types of elements, pivoting elements 171, mobile elements 172, secondary gap elements 173, and gap elements 174. Again many similarities can be observed with the preceding puzzles.

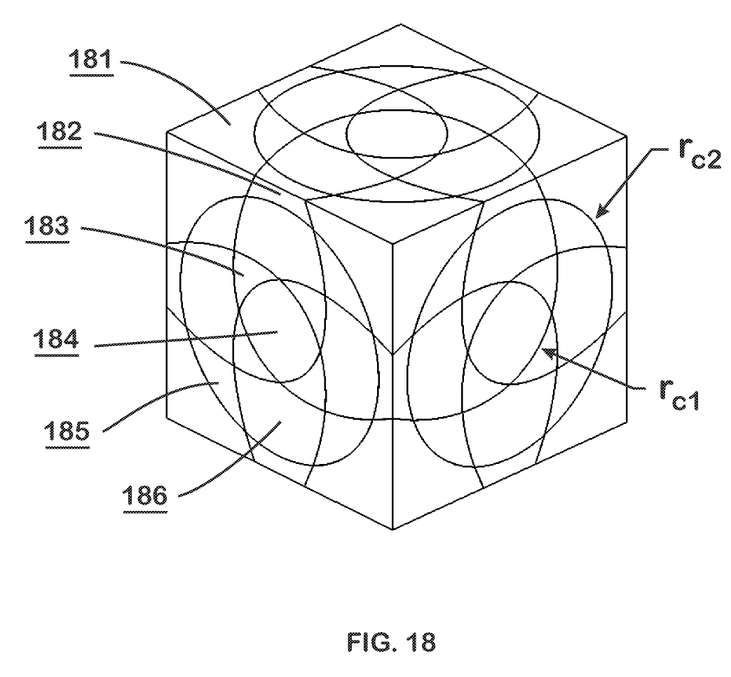

Reference is now made to FIG. 18 where a combination of a single-sliced circular octahedron face to cube vertex division with a mutli-pivoting single-sliced circular octahedron vertex to cube face division is shown and applied to a cube. These two divisions are carried at radius r_{c1} and r_{c2}. A very interesting cubic puzzle is than easily obtained by the application of the present dividing method. The resulting puzzle is constituted of six different types of elements, namely pivoting elements 181, mobile elements 182, secondary gap elements 183, gap elements 184, secondary pivoting elements 185, and secondary mobile elements 186. This puzzle can be easily complicated by applying other techniques available in the dividing method giving almost an infinity of possibilities.

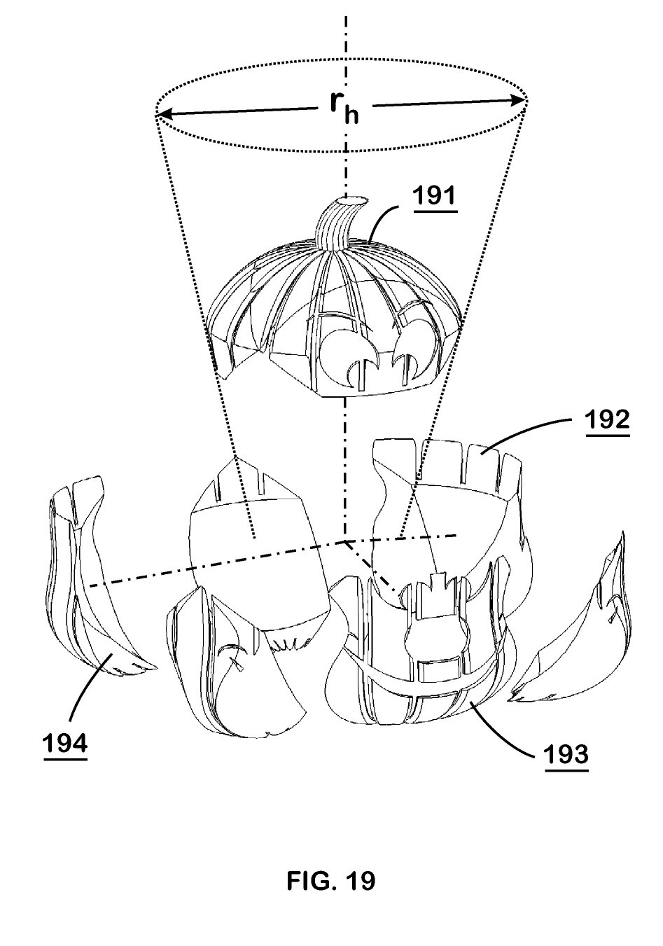

Reference is now made to FIG. 19 illustrating an exploded view of an odd-shaped solid divided by a single-sliced tetrahedron face division. In this figure, only the pivoting elements are identified. It is to be noted that each one has a different form. There are four pivoting elements, since a single-sliced tetrahedron face division is used, element 191, element 192, element 193, and element 194. They are all obtained from a division with circular geometrical figure of radius rₕ that is projected through a conically converging projection tunnel.

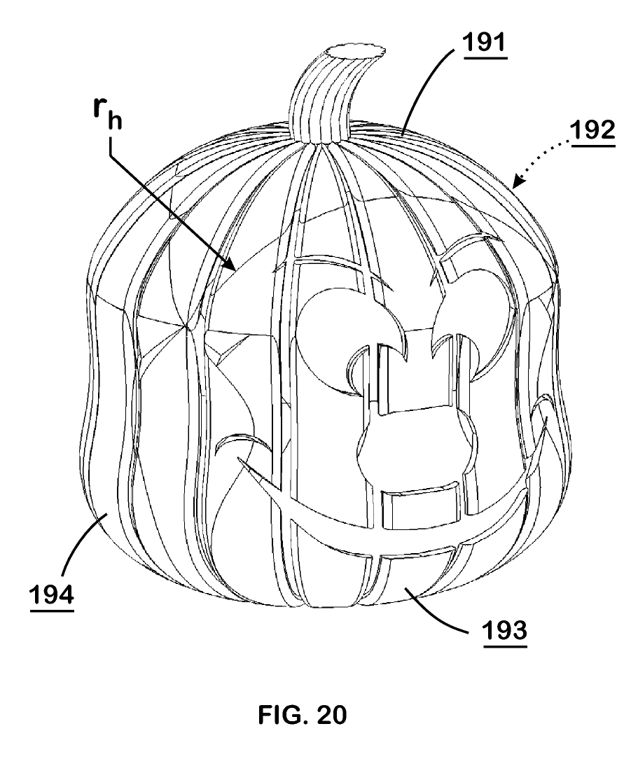

Reference is now made to FIG. 20 showing an assembled view of the odd-shaped solid of FIG. 19. These two figures present the extended possibilities of the dividing method applicable to any odd-shaped solid.

Reference is now made to FIG. 21 illustrating possible holding means used for holding the various puzzle elements in an interfitting relationship. Except for the three first illustrations, all the proposed holding means can be used for coreless puzzle purposes. The aim of these holding means is to prevent puzzle disassembly and enable shifting of some or all of the puzzle elements. The illustrations show various possible shapes for the holding means including tongue and groove mechanisms (which can be either male or female) being dovetail-shaped, T-shaped, L-shaped or of any shape that provides a holding means allowing rotation about at least one axis.

It is to be understood that the same techniques for arranging the display of colours, emblems, logos or other visual indicia on the outer surfaces of the puzzles to modulate the difficulty level of the puzzles presented in the prior art are also applicable to any of the puzzles obtained through the application of the novel dividing method disclosed herein. Complex descriptions of evoluted patterns are not included in the present disclosure for the sake of simplicity, but are well within the scope of the technology introduced here and can be easily derived from the principles already disclosed in the prior art and applied to the puzzles resulting from the present dividing method. Different visual indicia patterns (e.g. colours, logos, emblems, symbols, etc.) can be used to modulate the difficulty level of the puzzles. In other words, different versions of a given puzzle can be provided for novice, intermediate or expert players, or even for kids.

It should be noted that advertising, corporate logos or team logos could also be placed onto the surfaces of the puzzles obtained by the application of the present dividing method to create promotional vehicles or souvenirs.

Also worth mentioning is that it is possible to add sliding movements to the pre-existing shifting movement to further complicate the puzzles. Slidable elements can be added to underlying shiftable elements as described in Applicant's U.S. patent application Ser. No. 11/738,673. Generally, this is done by superimposing permutable sliding elements at the outer face of a given puzzle that slide in grooves in the underlying faces of said given puzzle to provide both shifting and sliding movements. Each superimposed sliding element slides in a curved track (the adjoining grooves) over the outer faces of non-sliding given puzzle elements along a circular slideway groove formed by adjacent grooves. Thus, adding sliding elements to a given shifting puzzle greatly increases the complexity of said given puzzle. Such given puzzle is now said to combine both shifting and sliding features.

All the aforesaid sliding modifications are analogous to the modifications introduced in Applicant's U.S. patent application Ser. No. 11/738,673, and therefore need not be repeated herein.

Other polyhedra of any kind could also be used as the guiding polyhedron for bisecting any given solid with the present dividing method, all without departing from the scope of the present invention. Likewise, the dividing method could also be applied to any polyhedron to achieve and create other interesting and challenging puzzles. Accordingly, the drawings and description are to be regarded as being illustrative, not as restrictive.

It will be noted that exact dimensions are not provided in the present description since these puzzles can be constructed in a variety of sizes.

While the puzzle elements and parts are preferably manufactured from plastic, these puzzles can also be made of wood, metal, or a combination of the aforementioned materials. These elements and parts may be solid or hollow. The motion of the puzzle mechanism can be enhanced by employing springs, bearings, semi-spherical surface knobs, grooves, indentations and recesses, as is well known in the art and are already well described in the prior art of shifting and sliding puzzles. Likewise, “stabilizing” parts can also be inserted in the mechanism to bias the moving elements to the “rest positions”, as is also well known in the art.

It is understood that the above description of the preferred embodiments is not intended to limit the scope of the present invention, which is defined solely by the appended claims.

1. A method of dividing an arbitrarily shaped solid or hollow structure to define perfectly interfitting parts covering an entire outer surface of a shiftable three-dimensional puzzle, the method comprising steps of:
selecting at least one guiding polyhedron;
defining an axis system based on the at least one guiding polyhedron, wherein axes of the axis system pass through all or a subset of geometrical centers of the faces, edges and vertices of the guiding polyhedron;
associating, with each axis, a planar geometrical figure defining a cutting contour for sectioning the structure when the contour is projected along the axis into the structure to be divided;
selecting a projection tunnel through which the cutting contour is to be projected, the projection tunnel defining how the cutting contour is to vary in size and shape when projected along each respective axis into the structure to be divided; and
dividing the structure into perfectly interfitting parts covering the entire outer surface of the puzzle using each of the contours associated with each of the one or more axes of the axis system.

2. The dividing method as claimed in claim 1 wherein the associating step comprises selecting a variable cross-section projection tunnel for defining how the contour is to vary in size and shape when projected along the respective axis.

3. The dividing method as claimed in claim 1 wherein the associating step comprises selecting a constant cross-section projection tunnel, whereby the contour is to remain fixed in size and shape when projected along the respective axis.

4. The dividing method as claimed in claim 1 wherein the step of associating the geometrical figure with each axis comprises steps of selecting a shape for each geometrical figure associated with the axes of the axis system and selecting a size for each geometrical figure.

5. The dividing method as claimed in claim 4 further comprising a step of applying a multi-slicing technique wherein the structure is sliced more than once along one or more of the axes of the axis system with contours of a different size.

6. The dividing method as claimed in claim 4 further comprising a step of applying a multi-pivoting technique wherein a circular geometrical figure is added to one or more axes of the axis system to divide the structure into pivoting groups of one or more elements.

7. The dividing method as claimed in claim 4 further comprising a step of applying a multi-guiding technique wherein one or more guiding polyhedra are superimposed as guides for multiple axis systems, with axes passing through all or a subset of geometrical centers of faces, edges and vertices of the guiding polyhedral whereby each axis of every additional axis system is associated with a projection tunnel and a geometrical figure which can be projected through the projection tunnel into an intersecting relationship with the structure in order to slice the structure into perfectly interfitting parts covering the entire outer surface of the structure.

8. The dividing method as claimed in claim 2 wherein the step of associating the geometrical figure contour with each axis comprises steps of selecting a shape for each geometrical figure associated with the axes of the axis system and selecting a size for each geometrical figure.

9. The dividing method as claimed in claim 8 further comprising a step of applying a multi-slicing technique wherein the structure is sliced more than once along one or more of the axes of the axis system with geometrical figure contours of a different size.

10. The dividing method as claimed in claim 8 further comprising a step of applying a multi-pivoting technique wherein a circular geometrical figure is added to one or more axes of the axis system to divide the structure into pivoting groups of one or more elements.

11. The dividing method as claimed in claim 8 further comprising a step of applying a multi-guiding technique wherein one or more guiding polyhedra are superimposed as guides for multiple axis systems, with axes passing through all or a subset of geometrical centers of faces, edges and vertices of the guiding polyhedral whereby each axis of every additional axis system is associated with a projection tunnel and a geometrical figure which can be projected through the projection tunnel into an intersecting relationship with the structure in order to slice the given solid into perfectly interfitting parts covering the entire outer surface of the structure.

12. The dividing method as claimed in claim 3 wherein the step of associating the geometrical figure contour with each axis comprises steps of selecting a shape for each geometrical figure associated with the axes of the axis system and selecting a size for each geometrical figure.

13. The dividing method as claimed in claim 12 further comprising a step of applying a multi-slicing technique wherein the structure is sliced more than once along one or more of the axes of the axis system with geometrical figure contours of a different size.

14. The dividing method as claimed in claim 12 further comprising a step of applying a multi-pivoting technique wherein a circular geometrical figure is added to one or more axes of the axis system to divide the structure into pivoting groups of one or more elements.

15. The dividing method as claimed in claim 12 further comprising a step of applying a multi-guiding technique wherein one or more guiding polyhedra are superimposed as guides for multiple axis systems, with axes passing through all or a subset of geometrical centers of faces, edges and vertices of the guiding polyhedral whereby each axis of every additional axis system is associated with a projection tunnel and a geometrical figure which can be projected through the projection tunnel into an intersecting relationship with the structure in order to slice the the structure into perfectly interfitting parts covering the entire outer surface of the structure.

16. The dividing method as claimed in claim 1 comprising at least one of the steps of:
selecting a shape for each geometrical figure associated with axes of the axis system;
selecting a projection tunnel for each associated axis;
selecting a size for each geometrical figure to be used for slicing the structure;
applying a multi-slicing technique wherein the structure is sliced more than once along at least one axis of the axis system with a geometrical figure contour of a different size;
applying a multi-pivoting technique wherein a circular geometrical figure contour is added to at least one axis of the axis system to divide the structure into a pivoting group of one or more elements; and
applying a multi-guiding technique wherein one or more guiding polyhedra are superimposed as guides for axis systems, with axes passing through all or a subset of geometrical centers of faces, edges and vertices of the guiding polyhedra, whereby each axis of each additional axis system is associated with a projection tunnel and a geometrical figure contour along which the geometrical figure contour can be projected into an intersecting relationship with the structure in order to slice the structure into perfectly interfitting parts covering the entire outer surface of the structure.

17. The dividing method as claimed in claim 16 wherein the guiding polyhedra are convex uniform polyhedra selected from the five platonic solids, the thirteen archimedean solids, the waterman solids, the prism solids, and the antiprism solids.

18. The dividing method as claimed in claim 17 wherein most of the associated geometrical figure contours are circular in order to create a mostly symmetrical three-dimensional puzzle when the structure is divided, wherein some of the interfitting parts act as pivoting elements while enabling substantially all of the other parts of the puzzle to be shifted.

19. The dividing method as claimed in claim 18 wherein the structure is a polyhedron.

20. The dividing method as claimed in claim 19 comprising a further step of superimposing sliding elements onto one or more outer surfaces of said puzzle.

21. The dividing method as claimed in claim 18 wherein the structure is a sphere.

22. The dividing method as claimed in claim 21 comprising a further step of superimposing sliding elements onto one or more outer surfaces of said puzzle.

23. The dividing method as claimed in claim 18 wherein the structure is odd-shaped.

24. The dividing method as claimed in claim 23 comprising a further step of superimposing sliding elements onto one or more outer surfaces of said puzzle.

25. The dividing method as claimed in claim 18 wherein edges of puzzle elements are configured as interfitting holding means to hold the puzzle together while enabling shifting of at least some of the puzzle elements.
